(19) United States
(12) Patent Application Publication
(10) Pub. No.: US 2017/0277852 A1
(43) Pub. Date: Sep. 28, 2017

(54) SMART LOGGING FOR MANAGEMENT OF HEALTH-RELATED ISSUES

(71) Applicant: Ascensia Diabetes Care Holdings AG, Basel (CH)

(72) Inventors: Jeffery S. Reynolds, New Fairfield, CT (US); Kuen Chang, Chicago, IL (US); Amy Lynn Schwartz, Evanston, IL (US); Aaron Ferber, Chicago, IL (US)

(73) Assignee: Ascensia Diabetes Care Holdings AG, Basel (CH)

(21) Appl. No.: 15/508,586

(22) PCT Filed: Sep. 8, 2015
(86) PCT No.: PCT/US2015/048981

§ 371 Date: Mar. 3, 2017

Related U.S. Application Data
(60) Provisional application No. 62/048,646, filed on Sep. 10, 2014.

(51) Int. Cl. G06F 19/00; G06Q 10/10

(52) U.S. Cl. CPC G06F 19/3418; G06Q 10/1095

(57) ABSTRACT

A system managing health-related issues (e.g., diabetes) includes a measurement device to measure a health characteristic and a processing device communicatively coupled to the measurement device. The processing device receives the measurement from the measurement device. The processing device includes at least one memory device, a processor, and a user interface. The at least one memory device stores the one or more measurements and computer-readable instructions for a healthcare application. The processor executes the healthcare application. The health care application displays and receives, via the user interface, supplemental health data in association with the one or more measurements. The healthcare application allows a user to input the supplemental data according to adherence burst prompting, measurement and logging prescription, retroactive logging, and/or data display with an electronic calendar. The healthcare application may prompt the user to take a measurement and to input the supplemental data according to these features.

### CROSS-REFERENCE TO RELATED APPLICATION

This application is a National Stage of International Application No. PCT/US2015/48981, filed Sep. 8, 2015, which claims the benefit of and priority to U.S. Provisional Application No. 62/048,646, filed Sep. 10, 2014, each of which is hereby incorporated by reference herein in its entirety.

### FIELD OF THE PRESENT DISCLOSURE

The present invention generally relates to management of health-related issues. More specifically, the present invention is directed to systems and methods that log health data for more effective management of health-related issues, including diabetes.

### BACKGROUND

The quantitative determination of analytes in body fluids is of great importance in the diagnoses and maintenance of certain physiological conditions. For example, persons with diabetes (PWDs) frequently check the glucose level in their bodily fluids. The results of such tests can be used to regulate the glucose intake in their diets and/or to determine whether insulin or other medication needs to be administered. A PWD typically uses a measurement device (e.g., a blood glucose meter) that calculates the glucose concentration in a fluid sample from the PWD, where the fluid sample is collected on a test sensor that is received by the measurement device.

### SUMMARY

Aspects of the present invention provide systems and methods for logging health data for more effective management of health-related issues (e.g., diabetes). In particular, embodiments employ a healthcare application that collects data according to adherence burst prompting, measurement and logging prescription, retroactive logging, and/or data display with an electronic calendar.

According to one embodiment, a system for diabetes management includes a measurement device configured to take a measurement of a health characteristic and a processing device communicatively coupled to the measurement device. The processing device receives the measurement from the measurement device. The processing device includes at least one memory device, a processor, and a user interface. The at least one memory device stores the one or more measurements and computer-readable instructions for a healthcare application. The processor executes the healthcare application. The health care application displays and receives, via the user interface, supplemental health data in association with the one or more measurements. The healthcare application allows a user to input the supplemental data according to adherence burst prompting, measurement and logging prescription, retroactive logging, and/or data display with an electronic calendar. The healthcare application may prompt the user to take the measurement and to input the supplemental data according to varying aspects of these features.

In another embodiment, the at least one memory device may store a plurality of previous measurements and identifies one or more previous measurements for retroactive entry of additional supplemental health data, and the healthcare application prompts the user to enter the additional supplemental health data retroactively. The at least one memory device may store a plurality of previous measurements and the healthcare application prompts the user to take the measurement and input the supplemental health data according to an analysis of the plurality of previous measurements. The at least one memory device may store computer-readable instructions for a calendar application and corresponding calendar data in which the processor executes the calendar application and the healthcare application prompts the user to input the supplemental health data based on the calendar data.

In a further embodiment, an apparatus comprises a measurement device configured to take a measurement of a health characteristic. The measurement device includes at least one memory device, a processor, and a user interface. The at least one memory device stores the one or more measurements and computer-readable instructions for a healthcare application. The processor executes the healthcare application and the healthcare application displays and receives, via the user interface, supplemental health data in association with the one or more measurements. The at least one memory device stores a prescription or schedule and the healthcare application prompts the user to take the measurement and input the supplemental health data according to the prescription or schedule.

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive. The invention is to cover all modifications, equivalents, and alternatives falling within the spirit and scope of the invention.

### BRIEF DESCRIPTION OF THE DRAWINGS

FIG. 1 illustrates an example system that helps persons with diabetes (PWDs) to log health data that can be used for more effective diabetes management according to aspects of the present invention.

FIG. 2 illustrates an embodiment of the example system of FIG. 1.

FIG. 3 illustrates an example method for adherence burst prompting is illustrated, according to aspects of the present invention.

FIG. 4 illustrates an example method employing a measurement and logging prescription, according to aspects of the present invention.

FIG. 5 illustrates an example method employing retroactive logging, according to aspects of the present invention.

FIGS. 6A-B illustrates example displays of blood glucose data with an electronic calendar, according to aspects of the present invention.

### DETAILED DESCRIPTION

Management of a health-related issue (e.g., diabetes) may involve analyzing recorded blood glucose data to develop a treatment plan. A treatment plan for a PWD may include regulating dietary carbohydrate intake, implementing an intake regimen of insulin or other medications. To improve the development of a treatment plan, systems and methods according to aspects of the present invention allow persons with diabetes to log health data for more effective diabetes management. Health data may include measurements of blood glucose that PWDs take with blood glucose meters. Health data may also include additional supplemental information that enhances an understanding of the recorded blood glucose data. For example, a PWD may log supplemental health data relating to his/her physical state, behavior, recent activities, and health-related events that may explain particular blood glucose data. A PWD may log any information on recent insulin intake, carbohydrate intake, physical activity (e.g., exercise), and general health (e.g., sickness, fatigue, etc.) relating to a specific blood glucose measurement. Each recorded blood glucose measurement can be associated with logged supplemental health data via, for example, a timestamp. In some cases, blood glucose data may be logged automatically or manually, while supplemental health data is logged manually by the PWD.

When developing a treatment plan, a health care provider (HCP) may find it useful to review large amounts of health data, which have been logged for blood glucose measurements taken frequently over a large period of time. It is extremely burdensome, however, for a PWD to log large amounts of data detailing the circumstances of each blood glucose measurement during a large period of time. Taking this reality into account, aspects of the present invention provide systems and methods for logging health data that provide sufficient information for developing an effective treatment plan, but minimize the amount of effort and inconvenience on the part of the PWD.

In particular, embodiments include one or more of the following features:
(1) Adherence Burst Prompting: Embodiments may prompt a PWD to take blood glucose measurements and log supplemental health data more frequently during a predefined time period. For example, a PWD may increase logging of blood glucose data and/or supplemental health data for a time period (e.g., approximately two weeks) just prior to a visit with an HCP. By logging more detailed and frequent health data during this brief period of time, the PWD provides a set of health data that represents blood glucose data, physical state, behavior (lifestyle), activities, and health-related events that the PWD typically experiences during other times. The PWD, however, is not required to conduct a burdensome and inconvenient level of measurement and logging for months. In other words, this feature provides the HCP with a detailed snapshot that allows the HCP to develop, review and/or revise a treatment plan for the PWD. The health data collected according to adherence burst prompting can also be analyzed with health data that is logged during other times.
(2) Measurement and Logging Prescription: Embodiments may prompt a PWD to take blood glucose measurements and to log certain health data according to a specific testing/logging prescription determined by an HCP. The testing/logging prescription identifies times and/or events when measurements and/or logging of certain supplemental health data provides greater information content for analysis by the HCP. For example, if a PWD is adopting a new insulin regimen, the PWD may be prompted to take measurements immediately before and after a meal and to log corresponding insulin and carbohydrate intake so that the HCP can evaluate the insulin regimen. As another example, if a PWD is having trouble with nocturnal hypoglycemia, the PWD may be prompted to log carbohydrate intake during evening meals and to take a measurement at bedtime. In yet another example, if a PWD has trouble remembering to take inulin or other medications, the PWD may receive reminders for taking such medications. It is contemplated that other testing/logging prescriptions may set forth other requirements for measurement and/or logging. In general, the testing/logging pattern is tailored to collect health data that is important for a particular PWD.
(3) Retroactive Logging: Embodiments may enhance convenience and efficiency by allowing a PWD to retroactively log health data. In other words, the PWD is not required to provide health data (particularly supplemental health data) at the time the measurement is taken. Rather, the PWD can log the health data later at a more convenient time. For example, retroactive logging can be achieved when the PWD has more free time, e.g., while waiting at an airport gate to board a flight. In some cases, embodiments can actively identify certain blood glucose data that may require supplemental information to be logged to explain the blood glucose data further. As such, the PWD may be actively prompted to provide, for certain blood glucose data, supplemental health data that may provide especially useful information for analyzing the blood glucose data. In particular, health data may be analyzed to identify events, anomalies, and other blood glucose data of interest and to prompt the user to retroactively log additional health data for the blood glucose data. For example, if a morning hypoglycemic event is identified in recorded blood glucose data, the PWD may be prompted to log additional health data relating to the event, e.g., information about the meal from the preceding evening, insulin doses, or exercise. In some cases, when prompted, the PWD may optionally and conveniently select from a predefined list of possible explanations for the identified blood glucose data.
(4) Data Display with Electronic Calendar: Embodiments may allow a PWD to use information stored in his/her personal electronic calendar to assist in providing supplemental information. Many people routinely schedule and track their daily activities using electronic calendars, which are widely available on many electronic devices, e.g., smart devices. Therefore, to enhance the convenience of logging supplemental health, embodiments allow a PWD to view blood glucose data with information from his/her electronic calendar. Embodiments may graphically display the blood glucose data over the electronic calendar as an overlay. Alternatively, embodiments may display the blood glucose data side by side. Embodiments may also allow convenient marking of calendar entries (e.g., with text and/or symbols) to be identified easily and paired with corresponding blood glucose data (with the appropriate date and time stamp). For example, a PWD may mark blood glucose data with calendar entries relating to scheduled workouts, holiday meals, travel, and events that may cause stress (e.g., important work deadlines, etc.). For instance, a calendar entry may be marked with a hashtag to associate the entry with a blood glucose measurement.

Present embodiments enable a PWD to efficiently log supplemental health data that increases the information content and value of corresponding blood glucose data. Embodiments allow targeted logging of health data. In addition, embodiments allow a PWD to provide more information with optimized logging (better information with minimum effort). Furthermore, embodiments allow HCPs to guide testing and logging to collect the health data they need to develop treatment plans and recommend lifestyle changes. By making the collection of health data more efficient and convenient, PWDs are encouraged to provide health data resulting in more accurate analysis and effective treatment.

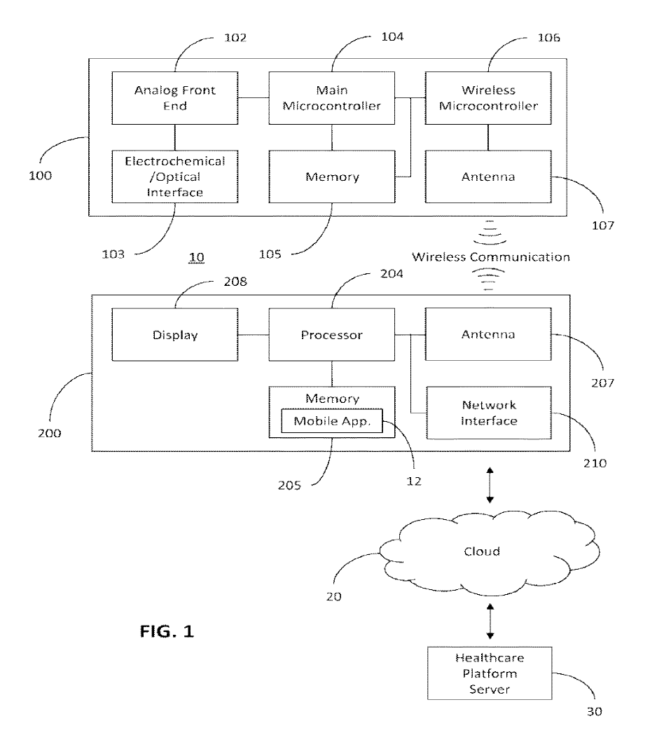

FIG. 1 illustrates an example system 10 for implementing the features described above. The system 10 includes a measurement device 100 and an external processing device 200. In particular, the measurement device 100 includes an analog front end 102, a measurement interface (e.g., an electrochemical or optical measurement) 103, a main microcontroller 104, a memory 105, a wireless microcontroller 106, and an antenna 107.

The analog front end 102 is coupled to the measurement interface 103, which includes hardware to receive a fluid sample directly or indirectly. In some embodiments, for example, the measurement device 100 measures the concentration of an analyte in the fluid sample. The fluid sample may include, for example, a whole blood sample, a blood serum sample, a blood plasma sample, other body fluids like ISF (interstitial fluid), saliva, and urine, as well as non-body fluids. Analytes that may be analyzed include glucose, lipid profiles (e.g., cholesterol, triglycerides, LDL and HDL), microalbumin, hemoglobin A1_{C}, fructose, lactate, or bilirubin. In general, aspects of the present invention may be employed to measure one or more characteristics of a sample, such as analyte concentration, enzyme and electrolyte activity, antibody titer, etc. Thus, although the examples described herein may relate to the measurement of blood glucose concentration, it is understood that aspects of the present invention may be employed for any type of health data collection.

In some embodiments, the measurement interface 103 includes a port that receives a test sensor (not shown) configured to receive the fluid sample directly. For example, a user may employ a lancing device to pierce a finger or other area of the body to produce a blood sample at the skin surface. The user may then collect this blood sample by placing the test sensor into contact with the sample. The test sensor contains a reagent which reacts with the sample to indicate the concentration of an analyte in the sample. In engagement with the test sensor, the measurement interface 103 allows the reaction to be measured by the analog front end 102.

In some cases, the test sensor may be an electrochemical test sensor. An electrochemical test sensor typically includes a plurality of electrodes and a fluid-receiving area that receives the fluid sample and includes appropriate reagent(s) (e.g., enzyme(s)) for converting an analyte of interest (e.g., glucose) in a fluid sample (e.g., blood) into a chemical species that produces an electrical current which is electrochemically measurable by the components of the electrode pattern. In such cases, the measurement interface 103 allows the analog front end 102 to be coupled to the electrodes of the test sensor, and the analog front end 102 receives a raw signal from the respective measurement interface 103.

In other cases, the test sensor may be an optical test sensor. Optical test sensor systems may use techniques such as transmission spectroscopy, diffuse reflectance, or fluorescence spectroscopy for measuring the analyte concentration. For example, an indicator reagent system and an analyte in a sample of body fluid can be reacted to produce a chromatic reaction, as the reaction between the reagent and analyte causes the sample to change color. The degree of color change is indicative of the analyte concentration in the body fluid. The color change of the sample can be evaluated to measure the absorbance level of a transmitted light. In such cases, the measurement interface 103 allows a light to be transmitted to the test sensor and the analog front end 102 to receive a raw optical signal based on the light absorbed by, and reflected from, the fluid sample on the test sensor.

In general, the analog front end 102 is employed to measure characteristic(s) of fluid samples received via the at least one measurement interface 103. It is understood that any number of measurement interfaces 103 (electrochemical, optical, etc.) may be coupled to the analog front end 102 to obtain any type of raw signal that can be translated into any type of measurement data.

Also coupled to the analog front end 102, the main microcontroller 104 controls operative aspects of the measurement device 100 as described further below. For example, the main microcontroller 104 can manage the measurement sequence that determines how the actual electrochemical or optical measurement is performed and how the raw electrochemical or optical signal is obtained by the analog front end 102 from the respective measurement interface 103. In addition, the main microcontroller 104 can determine how the raw signal received by the analog front end 102 is converted with a calculation sequence into a final measurement value (e.g., blood glucose concentration expressed as milligrams per deciliter (mg/dL)) that can be communicated to the user, e.g., by a display. Although the analog front end 102 and the main microcontroller 104 are shown separately in FIG. 1, it is contemplated that the main microcontroller 104 in alternative embodiments may include a sufficient analog front end to measure characteristic(s) of a fluid sample received via the at least one measurement interface 103. In addition, it is contemplated that the main controller 104 shown in FIG. 1 may generally represent any number and configuration of processing hardware and associated components required to manage the operation of the measurement device 100.

The memory 105 (e.g., non-volatile memory) may include any number of storage devices, e.g., EEPROM, flash memory, etc. The memory 105 may store measurement data. In addition, the memory 105 may store data, e.g., firmware, software, algorithm data, program parameters, patient entered (logged) data, calibration data, lookup tables, etc., that are employed in the operation of other components of the measurement device 200.

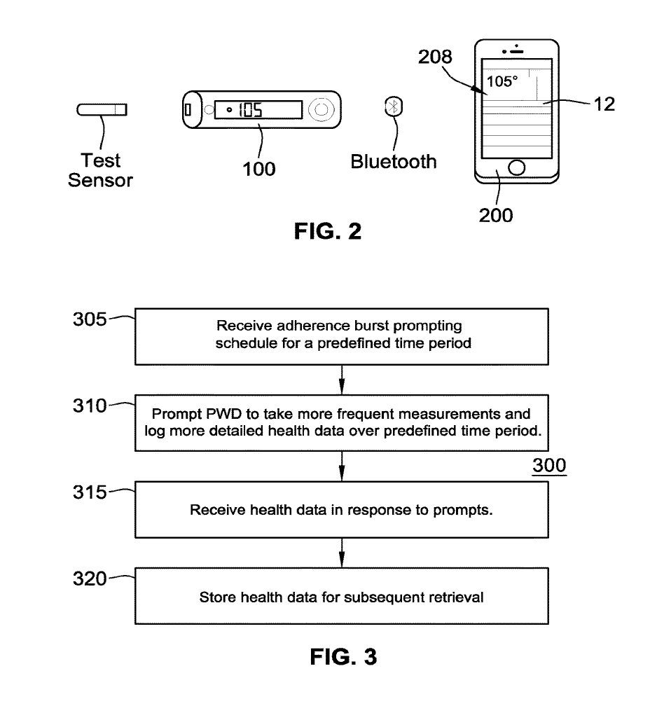

As further illustrated in FIG. 1, the measurement device 100 also includes an antenna 107 that allows the measurement device 100 to communicate wirelessly with the external processing device 200. As shown in FIG. 2, for example, the external processing device 200 may be a smart device, such as a smart telephone, that includes a mobile application that can be paired with the measurement device 100 to provide the testing/logging features described above. In other embodiments, the external processing device 200 may be a tablet computer, a handheld or pocket personal computer, a personal digital assistant (PDA), a desktop or laptop personal computer (PC), or other similar processing/communication devices employing any operating system and communication functions. Referring again to FIG. 1, the measurement device 100 may also include the wireless microcontroller 106 that controls communications through the antenna 107. Although the main microcontroller 104 and the wireless microcontroller 106 are shown separately in FIG. 1, it is contemplated that a common microcontroller in alternative embodiments may be employed to control the wireless communications in addition to other aspects of the measurement device 100.

The external processing device 200 also includes an antenna 207 that allows the external processing device 200 to communicate wirelessly with the measurement device 100. As shown in FIG. 2, the measurement device 100 and the external processing device 200, for example, may communicate via Bluetooth® wireless technology. In other embodiments, however, communication may be established by other wireless technologies, including near field communication (NFC), radio frequency (RF), personal area network (PAN), Wi-FiTM (IEEE 802.11), or the like. Alternatively or additionally, communication may be established by wired communication, e.g., universal serial bus (USB).

The external processing device 200 includes a processor 204 that generally controls aspects of the external processing device 200. For example, the processor 204 provides the processing required to run software applications that reside on the external processing device 200. A memory 205 on the external processing device 200 stores the computer-readable instructions for such software applications. The memory 205 may include non-volatile memory, such as flash memory or the like, to store user software applications.

According to aspects of the present invention, the memory 205 stores the computer-readable instructions for a healthcare application 12 that complements the operation of the measurement device 100. In particular, the healthcare application 12 can provide the testing/logging features described above. For example, as shown in FIG. 2, if the external processing device 200 is a smart device, e.g., a smart telephone, the healthcare application 12 may be a mobile application that is downloaded onto the smart device by the user and executed by the processor 204. The external processing device 200 provides a user interface to receive input from the user and a display 208, speakers, etc., to provide output to the user. In the example of FIG. 2, the external processing device 200 includes a touchscreen for receiving input and displaying output. The healthcare application 12 may store and/or process measurements and/or other data communicated wirelessly from the measurement device 100. In some cases, the healthcare application 12 may statistically analyze the measurement data and provide advanced display of the statistical analysis on the display 208 of the external processing device 200. Indeed, the healthcare application 12 may provide features that are not available through the measurement device 100 alone, particularly because the external processing device 200 may have greater processing and display capabilities than the measurement device 100.

In some embodiments, the healthcare application 12 is employed in a platform for delivering a variety of healthcare services relating to the use of the measurement device 100. For example, a company selling/distributing the measurement device 100 may provide its customers with the healthcare application 12 to provide features and services that enhance the measurement device 100. Because the measurement device 100 can be communicatively coupled to the external processing device 200, aspects of the present invention can employ applications on the external processing device 200 to expand the use of the measurement device 100. For example, the measurement device 100 can be coupled to the external processing device 200 so that the healthcare application 12 residing on the external processing device 200 can be used to provide the testing/logging features.

As shown in FIG. 1, the external processing device 200 includes a network interface 210 that allows the external processing device 200 to connect to an external network 20. The network interface 210 may employ any technique to connect to the external network 20. For example, the network interface 210 may connect with the external network 20 wirelessly, e.g., Wi-Fi™ (IEEE 802.11), cellular, etc., or via a wired technique, e.g., Ethernet, etc. The external network 20 may be any type of network, e.g., wide-area network (WAN), local-area network (LAN), cloud, etc.

Through the network interface 210, the external processing device 200 may access any resource available through the external network 20. In particular, the external processing device 200 can access resources that relate to the operation of the measurement device 100. As shown in FIG. 1, the external processing device 200 communicates with an external server 30 over the external network 20, shown for example as a cloud network. The external server 30 is related to some healthcare platform that delivers a variety of healthcare services relating to the use of the measurement device 100. For example, the external server 30 may act as the source of the healthcare application 12, which the external processing device 200 can receive over the external network 20 via the network interface 210. In addition, the external servers residing with access to the network or cloud-based servers may actually run the healthcare application with the user interface established via the network on the external processing device 200.

Because the external processing device 200 can be communicatively coupled to resources on an external network 20, the external processing device 200 can generally receive, from any external sources, data that can be used in association with the measurement device 100. Furthermore, because the external processing device 200 can be communicatively coupled to the measurement device 100, the measurement device 100 can in turn receive such data from the external sources.

In the system 10 of FIG. 1, the healthcare application 12 may be employed to provide any combination of: (1) adherence burst prompting, (2) measurement and logging prescription, (3) retroactive logging, or (4) data display with electronic calendar. The healthcare application 12, for example, may store the corresponding health data in the memory 205 of the external processing device 200, where it can be accessed and analyzed, e.g., by an HCP. Additionally or alternatively, the health data can be transmitted via the network interface 210 to an external server 30 of a healthcare platform, where it can also be accessed and analyzed.

The healthcare application 12 can prompt a PWD to take measurements and/or log supplemental health data according to adherence burst prompting. Adherence burst prompting helps a PWD to take blood glucose measurements and log supplemental health data more frequently and with more detail during a predefined time period. This time period can be determined, for example, by an HCP, so that the PWD can provide sufficient health data to develop a treatment plan without requiring the PWD to take more measurements and log more health data than is necessary. For example, an HCP may only require detailed health data for a two-week time period just before the PWD's next appointment with the HCP. Because making frequent measurements and logging more detailed health data over a two-week time period is more convenient and manageable than doing so over a longer time period (e.g., several months), the PWD is more likely to comply with the adherence burst prompting and provide the HCP with sufficient health data. It is contemplated that the time period may be shorter (e.g., 2-13 days or 4-10 days) or longer (e.g., 3 or 4 weeks).

In addition, the adherence burst prompting can be customized to accommodate specific aspects of the PWD and his/her lifestyle (i.e., a user profile) to enhance convenience and encourage compliance. Aspects of this user profile may be collected and stored by the healthcare application 12 on the external processing device 200 and/or an external server 30. For example, the user profile may indicate days and times when the user cannot take blood glucose measurements (e.g., during work commutes on public transportation, work meetings, etc.).

Referring to FIG. 3, an example method 300 employing adherence burst prompting is illustrated. In act 305, an adherence burst prompting schedule for a predefined time period is received. The initial set-up of the act 305 (adherence burst prompting) or ongoing HCP monitoring and in situ changes may be achieved by several methods. A PWD or HCP may set this up using the healthcare application and user interface of the PWD mobile device in one embodiment. In another embodiment, the HCP may have his or her own application running on the same mobile device or a separate platform (e.g., mobile device, computer, cloud application) that pushes the adherence burst prompting schedule to the healthcare application 12. In a further embodiment, this adherence burst set-up could be automatically initiated (likely after human authorization) by an interface between appointment scheduling software that can be part of an HCP's information system (e.g., practice management software, hospital information system, electronic health record system, or electronic medical record systems).

The adherence burst prompting schedule, for example, may be stored by the healthcare application 12 on the memory 205. As described above, an HCP may determine the adherence burst prompting schedule to collect sufficient and timely health data to develop a treatment plan for a PWD. In act 310, the PWD is prompted to take the more frequent measurements and/or log the more detailed health data over the predefined time period. The prompts may be communicated, for example, by the healthcare application 12 via the external processing device 200, e.g., via the display 208. The prompts may occur, for example, on an hourly basis, before or after meal times, or at any other appropriate times and/or intervals. In act 315, the health data (i.e., blood glucose data and any supplemental health data) is received in response to the prompts in step 310. The health data is then stored for subsequent retrieval and analysis in act 320. The PWD may input and store the health data via the healthcare application 12.

Additionally, the healthcare application 12 can prompt a PWD to take blood glucose measurements and to log health data according to a specific testing/logging prescription determined by an HCP. The term “prescription” includes guidance or instructions from an individual such as an HCP that influence the actions of the PWD or an application in relation to the PWD that uses available data. The testing/logging prescription identifies times and/or events when measurements and/or certain logging by the PWD provides a more informative set of health data for analysis by the HCP. Like the adherence burst prompting, the PWD is prompted to provide health data that is particularly useful for the HCP in developing a treatment plan. The testing/logging prescription can be defined so that the PWD is not required to take more measurements and log more health data than is necessary. By minimizing the burden of testing/logging on the PWD, the PWD is more likely to comply with the testing/logging prescription and provide the HCP with the necessary health data. In addition, the testing/logging prescription can be customized to accommodate specific aspects of the PWD and his/her lifestyle (i.e., a user profile) to enhance convenience and encourage compliance.

The initial set-up or ongoing HCP monitoring and in situ changes of the custom prescription logging scenario may be achieved by several methods. A PWD or HCP may set this up using the healthcare application and user interface of the PWD processing device in one embodiment. In another embodiment, the HCP may have his or her own application running on the same processing device or a separate platform (e.g., mobile device, computer, cloud application) that pushes the prescription logging/testing protocol to the healthcare application 12. In a further embodiment, this could be automatically initiated (likely after human authorization) through an interface with an HCP's information system (e.g., practice management software, hospital information system, electronic health record system, or electronic medical record systems). Besides convenience and accuracy in delivering the HCP's guidance, the use of a standalone HCP application would also be coupled seamlessly with data analysis algorithms to look at the data collected from the prescription testing as well as make logging instructions in the patient electronic medical records more accurate and less manually intensive.

For example, if a PWD is implementing a new insulin regimen, the HCP may be especially interested in monitoring the effects of meals and insulin intake on the glucose levels of the PWD. Accordingly, using measurement and logging prescription, the PWD is prompted to take measurements and log health data before and after meals. Additionally, the PWD is prompted with reminders to take insulin or other necessary medications on a schedule determined by the HCP. The health data logged according to the prescription allows the HCP to evaluate the insulin regimen.

In another example, a PWD may have a user profile that indicates that he/she normally eats lunch at noon and dinner at 7 PM. Based on this information, the HCP may, for instance, prescribe that the PWD should be prompted to take a blood glucose measurement and log supplemental data at 11:45 AM, 1 PM, 6:45 PM, and 7:15 PM. Of course, in other cases, the user profile may indicate that the user should be prompted at other appropriate times. In yet another example, if a PWD is having trouble with nocturnal hypoglycemia, the PWD may be prompted to log carbohydrate intake during evening meals and to take a blood glucose measurement at bedtime.

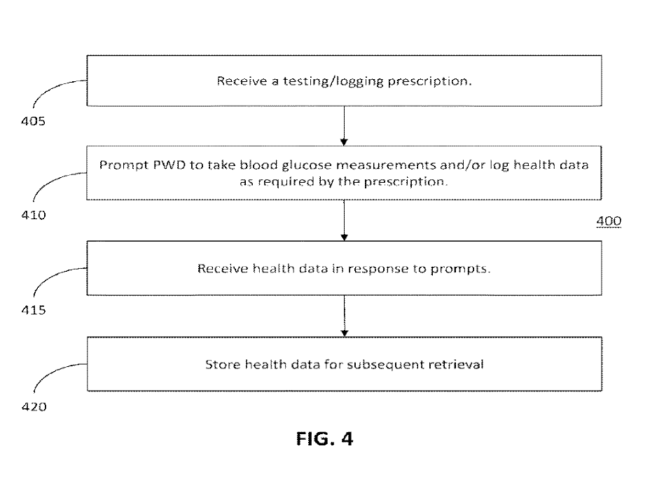

Referring to FIG. 4, an example method 400 employing a specific testing/logging prescription is illustrated. In act 405, a testing/logging prescription is received from an HCP. The prescription, for example, may be stored by the healthcare application 12 on the memory 205. As described above, an HCP defines the prescription to collect sufficient and timely health data, e.g., to develop or evaluate a treatment plan for a PWD. In act 410, the PWD is prompted to take blood glucose measurements and/or log health data as required by the prescription. The prompts may be communicated, for example, by the healthcare application 12 via the external processing device 200, e.g., via the display 208. In act 415, the health data (i.e., blood glucose data any supplemental health data) is received in response to the prompts in step 410. The health data is then stored for subsequent retrieval and analysis in act 420. The PWD may input and store the health data via the healthcare application 12.

Additionally, the healthcare application 12 allows a PWD to retroactively log health data. In other words, the PWD is not required to provide health data (particularly supplemental health data) at the time the measurement is taken. Rather, the PWD can log the health data later at a more convenient time. In some cases, embodiments can actively identify certain blood glucose data that may require supplemental information be logged to explain the blood glucose data further. As such, the PWD may be actively prompted to provide, for certain blood glucose data, supplemental health data that may provide especially useful information for analyzing the blood glucose data. In particular, health data may be analyzed to identify events, anomalies, and other blood glucose data of interest and to prompt the user to retroactively log additional health data for the blood glucose data.

The initial set-up or ongoing HCP monitoring and in situ changes of the retroactively logging scenario may be achieved by several methods. A PWD or HCP may set this up using the healthcare application and user interface of the PWD processing device in one embodiment. In another embodiment, the HCP may have his or her own application running on the same processing device or a separate platform (e.g., mobile device, computer, cloud application) that pushes the retroactively logging protocol to the healthcare application 12. In a further embodiment, this could be automatically initiated (likely after human authorization) through an interface with an HCP's information system (e.g., practice management software, hospital information system, electronic health record system, or electronic medical record systems). Besides convenience and accuracy in delivering the HCP's guidance, the use of a standalone HCP application would also be coupled seamlessly with data analysis algorithms to look at the data collected from the retroactively logging to make the patient electronic medical records more accurate.

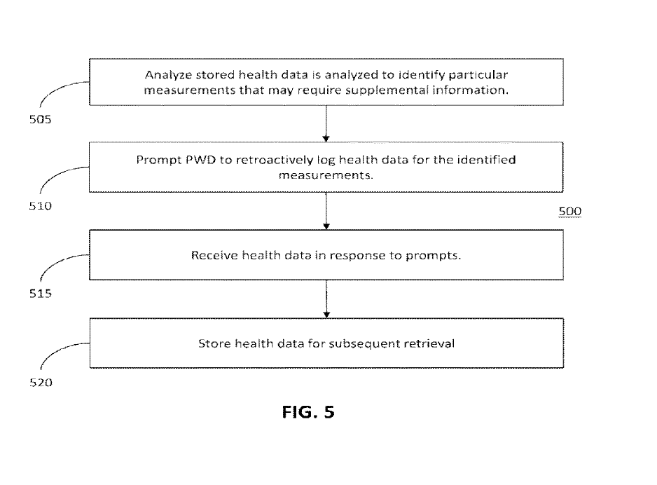

Referring to FIG. 5, an example method 500 employing retroactive logging is illustrated. In act 505, stored health data (e.g., blood glucose data) is analyzed to identify particular measurements that may require supplemental information to provide additional context for analysis and understanding of the particular measurements. The health data may be stored in the memory 205 and the healthcare application 12 may analyze the health data to prompt the PWD for further information. In some cases, pattern recognition may be employed to identify events, anomalies, and other blood glucose data of interest. For example, if blood glucose data for a PWD falls consistently within a certain range every morning, a value that falls significantly outside this range may trigger a prompt to the PWD requesting supplemental information for the value. In act 510, the PWD is prompted to retroactively log supplemental health data for the measurements identified in act 505. The prompts may be communicated, for example, by the healthcare application 12 via the external processing device 200, e.g., via the display 208. In act 515, supplemental health data is received in response to the prompts in step 510. The supplemental health data is then stored for subsequent retrieval and analysis in act 520. The PWD may input and store the supplemental health data via the healthcare application 12.

For example, if analysis of health data reveals that a PWD may be a morning hypoglycemic, act 505 may identify measurements taken during the evening that do not have corresponding supplemental health data. This supplemental health data may help an HCP determine why the PWD is experiencing low blood glucose levels in the morning. The supplemental health data may include, for example, information on the PWD's evening meals (e.g., carbohydrate intake), the PWD's bedtime, or any other information that may provide context for the blood glucose data of interest.

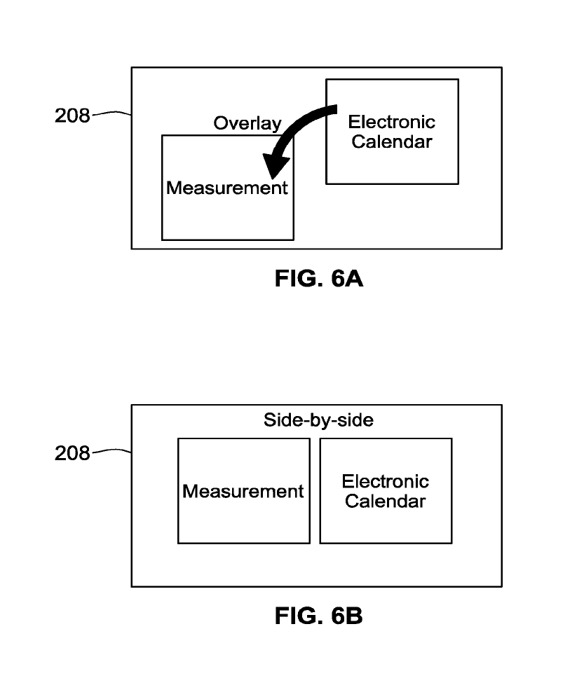

Referring to FIGS. 6A-B, the healthcare application 12 allows a PWD to use information stored in his/her personal electronic calendar to assist in providing supplemental information. In particular, if the external processing device 200 is a smart device, e.g., smart phone, the healthcare application 12 may access a calendar application typically available on such devices. To enhance the convenience of logging supplemental health, embodiments allow a PWD to view blood glucose data with information from his/her electronic calendar. Allowing a PWD to view logged health data with his/her electronic calendar is particularly convenient, as this allows the PWD to use calendar programs with which he/she is likely to be already familiar. As shown in FIG. 6A, embodiments may graphically display the blood glucose data over the electronic calendar as an overlay. Alternatively, as shown in FIG. 6B, embodiments may display the blood glucose data side by side. Embodiments may also allow convenient marking of calendar entries (e.g., with text and/or symbols) to be identified easily and paired with corresponding blood glucose data (with the appropriate date and time stamp). For example, a calendar entry may be marked with a hashtag to associate the entry with a blood glucose measurement.

In certain implementations, a PWD can receive prompts to take a measurement and/or log health data via the calendar application. These reminders can be displayed using the normal calendar interface, allowing the user to receive reminders more conveniently. The prompts may include, for example, adherence burst prompts, testing/logging prescription prompts, retroactive logging prompts, or any other relevant logging prompts. In addition to receiving prompts via the user's calendar application, in certain implementations, a PWD can log data directly into the calendar application that then can be accessed by the healthcare application 12.

In the examples above, the system 10 is employed, where the measurement device 100 (e.g., blood glucose meter) may be wirelessly coupled (e.g., via Bluetooth®) to an external processing device 200 (e.g., smart device) where a healthcare application 12 (e.g., mobile application) resides and is used to log, store, and view health care data. Although aspects of the present invention can be implemented with a healthcare application 12 running on the external processing device, it is understood that some aspects may alternatively or additionally implemented on a standalone measurement device (i.e., without being coupled to an external processing device).

For example, a measurement device may include at least one memory device, a processor and a user interface. The at least one memory device of the measurement device stores the one or more measurements and computer-readable instructions for a healthcare application. The healthcare application stored in the memory of the measurement device may allow a user to input the supplemental data according to (1) adherence burst prompting, (2) measurement and logging prescription, (3) retroactive logging, and/or (4) data display with an electronic calendar. The healthcare application may prompt the user to take the measurement and to input the supplemental data according to varying aspects of these features. Thus, the functionality of the healthcare applications described above in the system embodiments (processing device and measurement device) may be used in an apparatus with only the measurement device.

In addition, although the examples above relate generally to diabetes management, aspects of the present invention can be applied to other chronic disease and long term treatment management applications. For example, for patients with a heart monitor and implanted defibulator, a healthcare application may prompt the patient to carefully log medications, exercise, and other relevant information over a period of time before each visit so that the HCP can better analyze the performance of the medical devices and make necessary adjustments. Likewise, the healthcare application can be programmed so that the prompting is tailored to the particular patient and their clinical situation. There are times in life when people can be intensively adherent for limited periods. HCP's can use the aspects of the present invention to leverage the ability to request patients to engage in an adherence burst activity, e.g.,:

when first diagnosed

during pregnancy

New Year's resolution

something strange or out of the ordinary appears in one's therapy

just before or immediately after a doctor appointment

Aspects of the present invention may also allow tailoring based on an individual's therapy and adherence profile:

automated prompts

reminders

general user interface flow

While the invention is susceptible to various modifications and alternative forms, specific embodiments and methods thereof have been shown by way of example in the drawings and are described in detail herein. It should be understood, however, that it is not intended to limit the invention to the particular forms or methods disclosed, but, to the contrary, the intention is to cover all modifications, equivalents and alternatives falling within the spirit and scope of the invention.

1. A system comprising:
a measurement device configured to take a measurement of a health characteristic; and
a processing device communicatively coupled to the measurement device, the processing device receiving the measurement from the measurement device, the processing device including at least one memory device, a processor, and a user interface, the at least one memory device storing the measurement and computer-readable instructions for a healthcare application, the processor executing the healthcare application, the healthcare application displaying and receiving, via the user interface, supplemental health data in association with the measurement,
wherein the at least one memory device stores a prescription or schedule and the healthcare application prompts [[the]] a user to take the measurement and input the supplemental health data according to the prescription or schedule.

2. The system of claim 1, wherein the at least one memory device stores the schedule and the healthcare application prompts the user to take the measurement and input the supplemental health data according to the schedule.

3. The system of claim 2, wherein the at least one memory device stores a date and the schedule is defined for a period of time based on and prior to the date.

4. The system of claim 3, wherein the date relates to an appointment with a healthcare provider.

5. The system of claim 1, wherein the at least one memory device stores the schedule and wherein the at least one memory device stores a plurality of previous measurements and the schedule is defined based on the plurality of previous measurements.

6. The system of claim 1, wherein the at least one memory device stores the prescription and wherein the prescription is defined according to dates, times, events or combinations thereof.

7. The system of claim 6, wherein the events includes physical activity, medication intake, carbohydrate intake or any combination thereof.

8. The system of claim 1, wherein the measurement device communicates wirelessly with the processing device.

9. The system of claim 8, wherein the processing device is a smart device and the healthcare application is a mobile application.

10. The system of claim 1, wherein the measurement of the health characteristic is a blood glucose concentration.

11. The system of claim 1, wherein the at least one memory device stores a plurality of previous measurements and identifies one or more previous measurements for retroactive entry of additional supplemental health data, and the healthcare application prompts the user to enter the additional supplemental health data retroactively.

12. (canceled)

13. A system comprising:
a measurement device configured to take a plurality of measurements of a health characteristic; and
a processing device communicatively coupled to the measurement device, the processing device receiving the plurality of measurements from the measurement device, the processing device including at least one memory device, a processor, and a user interface, the at least one memory device storing the plurality of measurements and computer-readable instructions for a healthcare application, the processor executing the healthcare application, the healthcare application displaying and receiving, via the user interface, supplemental health data in association with the plurality of measurements,
wherein the at least one memory device stores computer-readable instructions for a calendar application and corresponding calendar data, the processor executing the calendar application, the healthcare application prompting [[the]] a user to input the supplemental health data based on the calendar data.

14. The system of claim 13, wherein the healthcare application displays, via the user interface, the calendar data for access by the user when prompting the user to input the supplemental health data.

15. The system of claim 13, wherein the measurement device communicates wirelessly with the processing device.

16. The system of claim 15, wherein the processing device is a smart device and the healthcare application is a mobile application.

17. The system of claim 13, wherein the plurality of measurements of the health characteristic is blood glucose concentrations.

18. The system of claim 13, wherein the system further comprises an external server communicatively coupled to the processing device via a network, the external server providing the computer-readable instructions for the healthcare application for storage in the at least one memory device.

19-20. (canceled)

21. An apparatus comprising:
a measurement device configured to take a measurement of a health characteristic, the measurement device includes at least one memory device, a processor, and a user interface, the at least one memory device storing the measurement and computer-readable instructions for a healthcare application, the processor executing the healthcare application, the healthcare application displaying and receiving, via the user interface, supplemental health data in association with the measurement,
wherein the at least one memory device stores a plurality of previous measurements and the healthcare application prompts a user to take the measurement and input the supplemental health data according to an analysis of the plurality of previous measurements.

22. The system of claim 1, wherein the supplemental health data relates to a physical state, a behavior, health-related events, insulin intake, carbohydrate intake, physical activity, a bedtime, or any combination thereof.

23. The system of claim 1, wherein the measurement is automatically stored by the processing device and the supplemental health data is manually stored by the processing device.
